(19) United States
(12) Patent Application Publication
(10) Pub. No.: US 2010/0077105 A1
(43) Pub. Date: Mar. 25, 2010

(54) Role Switching Method Performed in Dual Role Device, and the Dual Role Device

(75) Inventors: Chang Mo Chung, Yongin-si (KR); Yon Suk Kim, Daejeon (KR)

Correspondence Address: F. CHAU & ASSOCIATES, LLC, 130 WOODBURY ROAD, WOODBURY, NY, 11797, US

(73) Assignee: Samsung Electronics Co., LTD., Suwon-si (KR)

(21) Appl. No.: 12/556,195

(22) Filed: Sep. 9, 2009

(30) Foreign Application Priority Data
Sep. 25, 2008 (KR) 10-2008-0094172

(51) Int. Cl. G06F 3/00

(52) U.S. Cl. 710/5

(57) ABSTRACT

A method for switching a dual role device (DRD) between the roles of a host and a device is provided. In the role switching method, when there is a request from a DRD desiring a role switch, a partner DRD may switch its own role. The role may be switched based on a plurality of consecutive micro-scheduled management commands (MMCs) or based on specific bit values included in a wireless universal serial bus (W-USB) application specific information element (ASIE) of a beacon slot. Therefore, the role switching method may reduce overhead by not having to simultaneously and continuously maintain a default link and a reverse link. The DRD may perform the role switching method.

### CROSS-REFERENCE TO RELATED APPLICATION

This application claims priority to Korean Patent Application No. 10-2008-0094172, filed Sep. 25, 2008, the contents of which are herein incorporated by reference in its entirety.

### BACKGROUND

1. Technical Field

The present inventive concept relates to a dual role device, and more particularly, to a role switching method performed in dual role device, and the dual role device.

2. Discussion of the Related Art

A point-to-point dual role device (DRD) described in the wireless Universal Serial Bus (W-USB) version 1.0 standard has a structure that is capable of properly performing its functions only when both a default link and a reverse link are continuously maintained from the beginning of an association therebetween. Accordingly, the conventional point-to-point DRD should maintain both the default link and the reverse link simultaneously in order to share an initial connection context (CC), for example, a connection host identifier (CHID), a connection device ID (CDID), and a clock CK. Thus, overhead increases and a significant level of power is consumed by each of a plurality of devices that constitute the DRD.

### SUMMARY

Exemplary embodiments of the present inventive concept provide a role switching method performed in a point-to-point dual role device (DRD) which does not need to maintain both a default link and a reverse link simultaneously, in contrast with a conventional point-to-point DRD which requires that these links be simultaneously and continuously maintained. Accordingly overhead and the amount of power consumed by devices that constitute the point-to-point DRD and the DRD performing the role switching method may be reduced.

According to an exemplary embodiment of the present inventive concept, there is provided a role switching method performed in a DRD, the method including receiving a request command from a device DRD that requires a role switch, wherein the receiving is performed in a host DRD; and consecutively transmitting M micro-scheduled management commands (MMCs) to the device DRD, when the host DRD accepts the request command, wherein the transmitting is performed in the host DRD and M is a positive integer.

Each of the M MMCs may include a connection host identifier (CHID) and a role switch acknowledgement information element (IE) that may include information about timing when the device DRD is to transmit the MMCs to the host DRD. The device DRD may transmit the request command including a connection device ID (CDID) to the host DRD via a device notification time slot (DNTS). The M may be 3.

According to an exemplary embodiment of the present inventive concept, there is provided a role switching method performed in a DRD, the method including determining a switch from a host role to a device role when the role switch is needed, wherein the determining is performed in a host DRD; and consecutively transmitting M MMCs to a device DRD, wherein the transmitting is performed in the host DRD and M is a positive integer, wherein each of the M MMCs includes a role switch IE.

According to an exemplary embodiment of the present inventive concept, there is provided a role switching method performed in a DRD, the method including receiving a first superframe including a first indicator from a current device DRD when the current device DRD wants to play a host role, wherein the receiving is performed in a current host DRD; and transmitting to the current device DRD a second superframe including a second indicator, the second indicator having values identical to or different from a value of an indicator previously transmitted to the device DRD, in response to the received first indicator, wherein the transmitting is performed in the current host DRD.

Each of the first and second indicators may be included in a wireless universal serial bus (W-USB) application specific information element (ASIE) of a beacon slot. Each of the first and second indicators may include 2 bits.

The device DRD may continuously play a role of a device DRD in response to the second indicator having the identical values. The current device DRD may continuously play a role of a host DRD in response to the second indicator having the different values.

According to an exemplary embodiment of the present inventive concept, there is provided a role switching method performed in a DRD, the method including transmitting a first superframe including a first indicator that indicates a role switch to a current device DRD when a current host DRD wants the role switch, wherein the transmitting is performed in the current host DRD; and transmitting a second superframe including a second indicator to the current host DRD whose role has been switched to the role of a device DRD, wherein the transmitting is performed in the current device DRD whose role has been switched to the role of a host DRD in response to the first indicator.

Each of the first and second indicators may be included in an ASIE of a WiMedia superframe. A recording medium may record a computer program for executing each of the role switching methods.

According to an exemplary embodiment of the present inventive concept, there is provided a DRD including a program memory storing a program for executing a role switching operation; and a processor performing the program stored in the program memory.

The processor may receive a request command from an external device DRD which may require a role switch via a media access control (MAC)/Physical Layer (PHY) block, and consecutively transmits M (where M is a positive integer) MMCs to the external device DRD via the MAC/PHY block according to a program which is executed when the request command is accepted.

According to an exemplary embodiment of the present inventive concept, there is provided a DRD capable of switching its role from a host DRD to a device DRD, the DRD including a program memory storing a program for executing a role switching operation; and a processor performing the program stored in the program memory.

The processor may determine a role switch to the role of the device DRD according to a program which is executed when the role switch is executed, and consecutively transmits M MMCs each including a role switch IE to an external device DRD via a MAC/PHY block.

According to an exemplary embodiment of the present inventive concept, there is provided a DRD including a program memory storing a program for executing a role switching operation; and a processor performing the program stored in the program memory. The processor receives a first superframe including a first indicator from an external device DRD via a MAC/PHY block every time the external device DRD wants to play a host role, and transmits a second superframe including a second indicator, the second indicator having values identical to or different from a value of an indicator previously transmitted to the external device DRD, to the external device DRD via the MAC/PHY block in response to the received first indicator.

The second indicator having the identical values may be an indictor that allows the external device DRD to play a role of a device DRD. The second indicator having the different values may be an indictor that allows the external device DRD to play a role of a host DRD.

According to an exemplary embodiment of the present inventive concept, there is provided a DRD including a program memory storing a program for executing a role switching operation; and a processor performing the program stored in the program memory. The processor transmits a first superframe including a first indicator that indicates a role switch to an external DRD via a MAC/PHY block only when the role switch is required, receives a second superframe including a second indicator from the external device DRD whose role has been switched to the role of a host DRD in response to the first indicator, via the MAC/PHY block, and receives an MMC from the external device DRD via the MAC/PHY block.

### BRIEF DESCRIPTION OF THE DRAWINGS

Exemplary embodiments of the present inventive concept will be more clearly understood from the following detailed description taken in conjunction with the accompanying drawings in which:

FIG. 1 is a flowchart illustrating a role switching method according to an exemplary embodiment of the present inventive concept;

FIG. 2 illustrates an example of a data packet that may be used;

FIG. 3 illustrates an example of a micro-scheduled management command (MMC) packet that may be used;

FIG. 4 is a flowchart illustrating a role switching method according to an exemplary embodiment of the present inventive concept;

FIG. 5 is a flowchart illustrating a role switching method according to an exemplary embodiment of the present inventive concept;

FIG. 6 illustrates a WiMedia superframe according to an exemplary embodiment of the present inventive concept;

FIG. 7 is a flowchart illustrating a role switching method according to an exemplary embodiment of the present inventive concept; and

FIG. 8 is a conceptual block diagram of a dual role device (DRD) capable of performing a role switch, according to an exemplary embodiment of the present inventive concept.

### DETAILED DESCRIPTION OF THE EXEMPLARY EMBODIMENTS

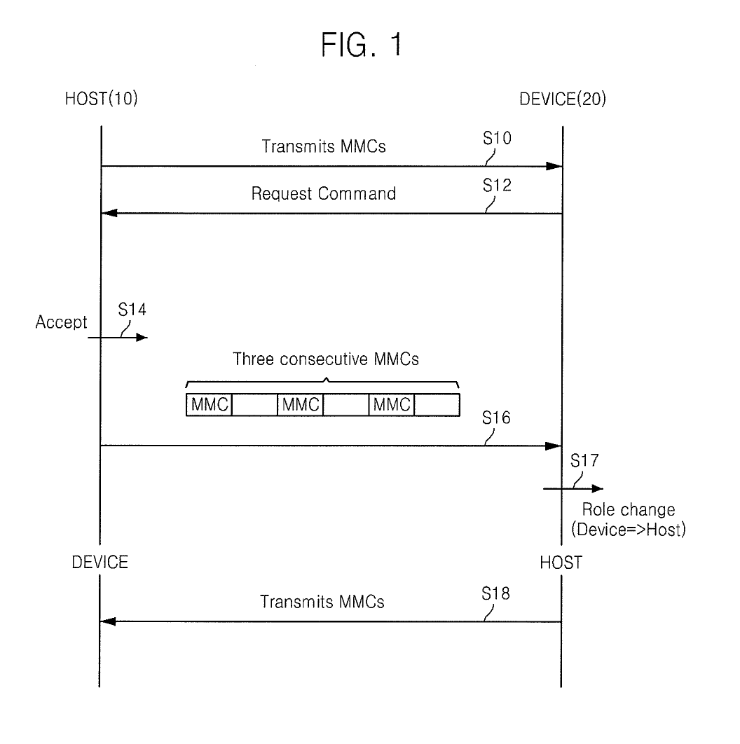

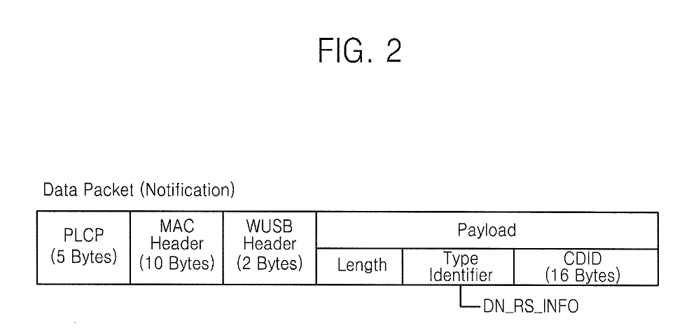

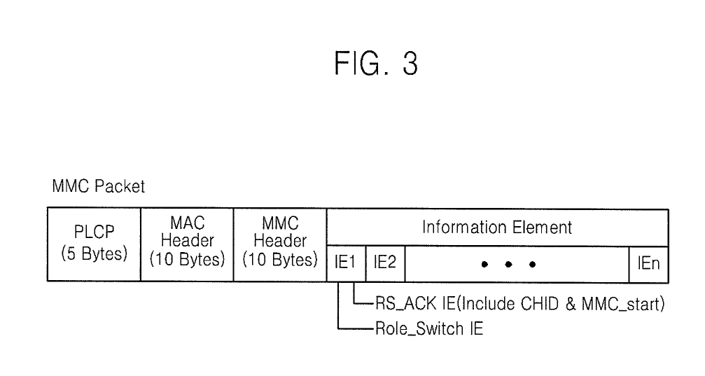

FIG. 1 is a flowchart illustrating a role switching method according to an exemplary embodiment of the present inventive concept. FIG. 2 illustrates an example of a data packet that may be used with the role switching method. FIG. 3 illustrates an example of a micro-scheduled management command (MMC) packet that may be used with the role switching method.

Referring to FIG. 1, a point-to-point wireless-Universal Serial Bus (W-USB) dual role device (DRD) (a DRD system or a DRD model) includes a host DRD 10 and a device DRD 20. Each of the host DRD 10 and the device DRD 20 may be a TV, a PC, a game controller, a printer, a scanner, a digital camera, an MP3 player, a hard disk, a solid state drive (device), a personal digital assistants (PDA), a mobile phone, a portable multimedia player (PMP), an adaptor, a hub, a set-top box, a WiNet client, a network attached storage (NAS), a flash memory device, or the like. The role switching method according to an exemplary embodiment of the present inventive concept may be applied to communications between mobile communication terminals using a certified wireless USB (CW-USB).

MMCs are used to help hosts and devices discover information about a W-USB cluster, notify their intentions, manage power, and schedule data transmissions efficiently to maintain high throughputs. MMCs are UWB control frames that include Information Elements (IE). In conventional wired USB, Start of Frame (SOF) packets are regularly sent between hosts and devices and are used for synchronization. SOFs also may be used to ensure that hosts and devices will not enter a power-down mode. Wireless USB does not use SOF packets, but rather transmits MMCs to all hosts and devices from time to time to maintain synchronization.

The host DRD 10 transmits MMCs, and the device DRD 20 receives the MMCs. The DRD model or the point-to-point DRD model according to an exemplary embodiment of the present inventive concept does not need to perform simultaneous maintenance of a default link and a reverse link, and accordingly, power consumption may be reduced by not continuously maintaining these links. A method in which the host DRD 10 switches its role in response to a role switching request command received from the device DRD 20 will now be described with reference to FIGS. 1 through 3.

In operation S10, the host DRD 10 may transmit MMCs to the device DRD 20. In operation S12, the device DRD 20 transmits the role switching request command to the host DRD 10 via a device notification time slot (DNTS) only when a role switch, a role change, or a role swap is wanted.

In this case, as illustrated in FIG. 2, an example of a data packet transmitted from the device DRD 20 to the host DRD 10 includes a physical layer convergence protocol (PLCP), a media access control (MAC) header, a WUSB header, and a payload. The payload includes a length field, a type identifier field, and a connection device identifier (CDID) field. In FIG. 2, numbers put in brackets represent an example field size in bytes. For example, the CDID field may be 16 bytes.

A role switching request command DN_RS_INFO transmitted from the device DRD 20 to the host DRD 10 may be included in the type identifier field of the payload shown in FIG. 2. If the host DRD 10 accepts a role switch request in response to the role switching request command in operation S14, the host DRD 10 transmits M consecutive MMCs (or MMC packets) to the device DRD 20, in operation S16. Here, M is a positive integer, for example, 3, although other positive integers may be used.

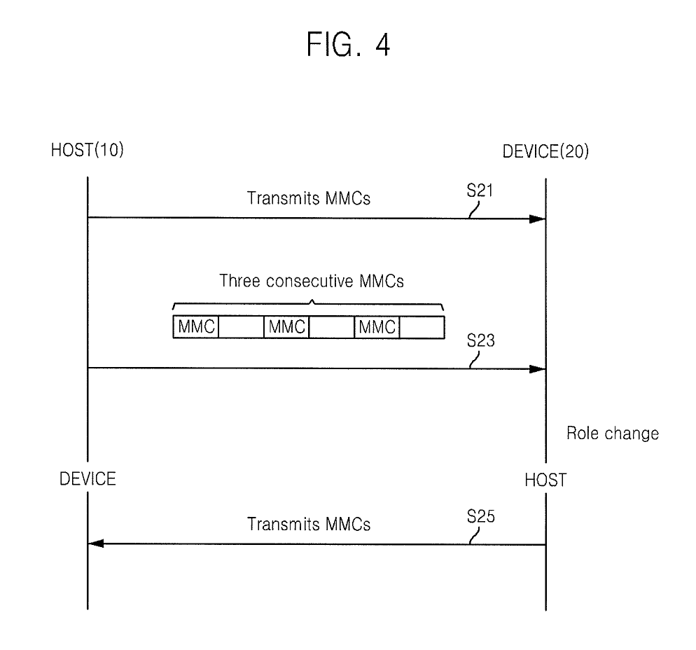

As illustrated in FIG. 3, each of the MMCs includes a PLCP, a MAC header, an MMC header, and an information element (IE). The IE includes n IEs. Here, n denotes a positive integer. For example, a first IE IE1 may include a role switch IE Role_Switch IE described below with reference to FIG. 4 or a role switch acknowledgement IE RS_ACK IE described below with reference to FIG. 1.

Each of the M consecutive MMCs includes the role switch acknowledgement IE RS_ACK IE. The role switch acknowledgement IE RS_ACK IE includes a connection host ID (CHID) and timing information MMC_start. For example, the CHID may be 16 bytes. The timing information MMC_start represents the timing when the device DRD 20 whose role has been switched to a host role is to transmit an MMC to the host DRD 10 whose role has been switched to a device role.

In operation S17, the device DRD 20 changes its device role to a host DRD in response to the M consecutive MMCs. Accordingly, in operation S18, the device DRD 20 may transmit the MMCs to the host DRD 10 whose role has been switched to a device DRD. However, if the host DRD 10 does not accept the role switching request, the respective unique roles of the host DRD 10 and the device DRD 20 are not switched.

As described above with reference to FIGS. 1, 2, and 3, since the device DRD 20 can output the role switching request command to the host DRD 10 every time the role switch is needed, the point-to-point DRD (or the DRD model) may reduce overhead, as compared with a conventional point-to-point DRD that maintains a default link and a reverse link simultaneously. In addition, since the point-to-point DRD (or the DRD model) according to an exemplary embodiment does not need to maintain the default link and the reverse link simultaneously all the time, channel usability may be increased. Therefore, the host DRD 10 and the device DRD 20 according to an exemplary embodiment may reduce power consumption.

FIG. 4 is a flowchart illustrating a role switching method according to an exemplary embodiment of the present inventive concept. A method in which the host DRD 10 requests the device DRD 20 to perform role switch will now be described with reference to FIGS. 3 and 4.

In operation S21, a host DRD transmits MMCs to a device DRD. If the host DRD wants its host role to be switched to a device role, the host DRD determines execution of the role switch and transmits M MMCs to the device DRD consecutively, in operation S23. As illustrated in FIG. 3, each of the M MMCs includes the role switch IE Role_Switch IE within the first IE IE1.

The device DRD switches its own role to a host role in response to the role switch IE Role_Switch IE included in at least one of the M MMCs. In this case, in operation S25, the device DRD transmits the MMCs to the host DRD whose host role has been switched to a device role.

FIGS. 1 through 4 illustrate methods of switching a role by using a WUSB internal mechanism of each of the host DRD 10 and the device DRD 20, which constitute the point-to-point DRD according to exemplary embodiments, when role switch is needed.

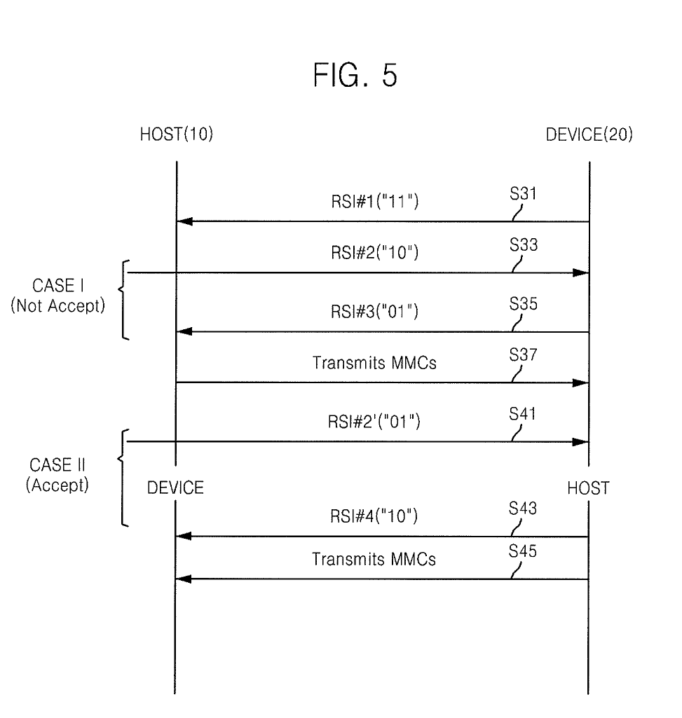

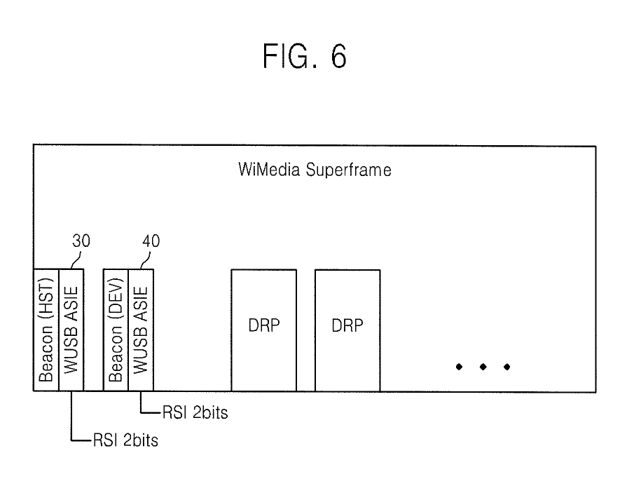

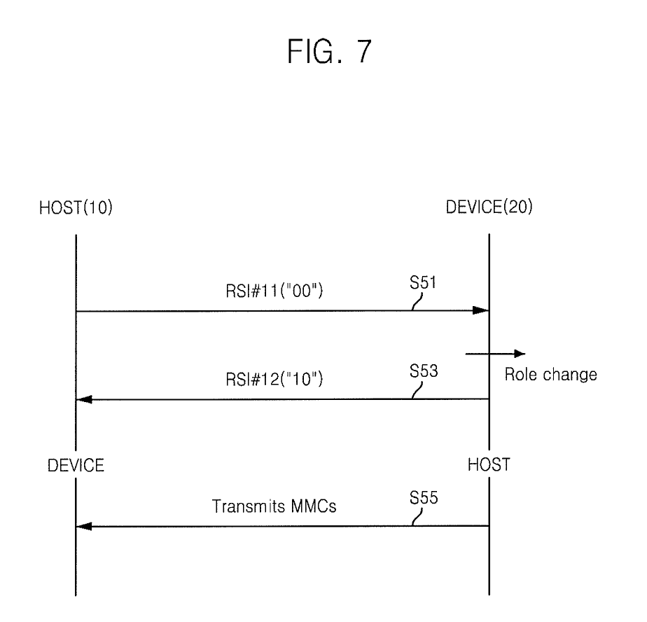

FIG. 5 is a flowchart illustrating a role switching method according to an exemplary embodiment of the present inventive concept. FIG. 6 illustrates a WiMedia superframe according to an exemplary embodiment of the present inventive concept. FIG. 7 is a flowchart illustrating a role switching method according to an exemplary embodiment of the present inventive concept. FIGS. 5 through 7 are flowcharts illustrating a role switching method using a WUSB application specific information element (ASIE). Accordingly, FIGS. 5 through 7 are flowcharts illustrating a role switching method using a WiMedia beacon mechanism.

Referring to FIG. 6, the WiMedia superframe includes a host beacon slot beacon(HST) including a WUSB ASIE 30, a device beacon slot beacon(DEV) including a WUSB ASIE 40, and a plurality of distributed reservation protocols (DRPs).

A role switch indicator (RSI) is made up of 2 bits, and each of the WUSB ASIEs 30 and 40 includes the RSI. A host DRD transmits the WUSB ASIE 30 including the RSI to the device DRD, and a device DRD transmits the WUSB ASIE 40 including the RSI to the host DRD. Here, A is a positive integer, for example, 2.

Referring to FIG. 5, in the default link, the host DRD 10 transmits the WUSB ASIE 30 of the host beacon slot beacon(HST) including ‘10’ (=RSI) to the device DRD 20. A most significant bit (MSB) ‘1’ in ‘10’ represents that a DRD which transmits an RSI is the host DRD 10, and a least significant bit (LSB) ‘0’ in ‘10’ represents that a DRD which receives the RSI is the device DRD 20. At this time, the device DRD 20 transmits the WUSB ASIE 40 of the device beacon slot beacon(DEV) including ‘01’(=RSI) to the host DRD 10 in response to the LSI ‘10’ received from the host DRD 10. An MSB ‘0’ in ‘01’ represents that a DRD which transmits an RSI is the device DRD 20, and an LSB ‘1’ in ‘01’ represents that a DRD which receives the RSI is the host DRD 10.

A method in which the host DRD 10 changes its role in response to an RSI output from the device DRD 20 will now be described with reference to FIGS. 5 and 6. In operation S31, the device DRD 20 desiring to play a host role transmits a first RSI RSI#1, for example, ‘11’, to the host DRD 10. When the host DRD 10 does not accept a role switch as in case I, the host DRD 10 transmits a second RSI RSI#2, for example, ‘10’, to the device DRD 20, in operation S33. Then, the device DRD 20 transmits a third RSI RSI#3, for example, ‘01’, to the host DRD 10, in operation S35. Accordingly, the host DRD 10 as a host transmits MMCs to the device DRD 20, in operation S37.

On other hand, when the host DRD 10 accepts the role switch as in case II, the host DRD 10 transmits a second RSI RSI#2′, for example, ‘01’, to the device DRD 20, in operation S41. At this time, the host DRD 10 transmits, to all device DRDs (including the device DRD 20) connected with the host DRD 10, a disconnection command that requests disconnection from the host DRD 10, and stops transmitting MMCs to all of the devices DRDs including the device DRD 20. Then, the device DRD 20 whose role has been switched to a host role transmits a fourth RSI RSI#4, for example, ‘10’, to the host DRD 10 whose role has been switched to a device role, in operation S43. Thereafter, in operation S45, the device DRD 20 whose role has been switched to a host role transmits MMCs to the host DRD 10 whose role has been switched to a device role, within a legacy distributed reservation protocol (DRP) period.

FIG. 7 is a flowchart illustrating a role switching method according to an exemplary embodiment of the present inventive concept. A method in which the device DRD 20 switches a role in response to an RSI output from the host DRD 10 will now be described with reference to FIGS. 6 and 7. In operation S51, the host DRD 10 desiring its role to be switched to a device role transmits a fifth RSI RSI#11, for example, ‘00’, to the device DRD 20, transmits, to all device DRDs (including the device DRD 20) connected with the host DRD 10, a disconnection command that requests a disconnection from the host DRD 10, and stops transmitting MMCs to all of the device DRDs including the device DRD 20.

In operation S53, the device DRD 20 whose role has been switched to a host role transmits a sixth RSI RSI#12, for example, ‘10’, to the host DRD 10 whose role has been switched to a device role. Then, in operation S55, the device DRD 20 whose role has been switched to a host role transmits the MMCs to the host DRD 10 whose role has been switched to a device role.

As described above with reference to FIGS. 5 through 7, if bit values that constitute an RSI are all identical to one another (for example, in case of ‘11’ or ‘00’), the host DRD 10 or the device DRD 20 may determine that the other party wants a role switch. The number of bits and the values of the bits described above are just examples used to explain an RSI according to one or more exemplary embodiments of the present inventive concept and it is to be understood that different numbers of bits and/or values may be used.

As described above with reference to FIGS. 5, 6, and 7, the device DRD 20 outputs an RSI having special bit values (for example, ‘11’) to the host DRD 10 when the role switch is needed, and the host DRD 10 outputs an RSI having special bit values (for example, ‘00’) to the device DRD 20 when the role switch is needed, so that the point-to-point DRD (or the DRD model) may have reduced overhead, as compared with a conventional point-to-point DRD that maintain a default link and a reverse link simultaneously. In addition, the point-to-point DRD (or the DRD model) according to exemplary embodiment of the present inventive concept does not need to maintain the default link and the reverse link simultaneously and continuously, so that channel usability may be increased. Therefore, the host DRD 10 and the device DRD 20 according to exemplary embodiments of the present inventive concept may have reduced power consumption.

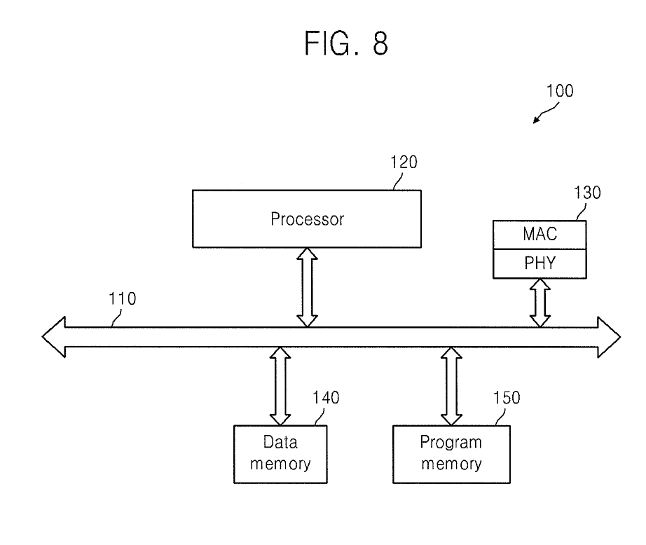

FIG. 8 is a conceptual block diagram of a DRD 100 capable of performing a role switch, according to an exemplary embodiment of the present inventive concept. Referring to FIG. 8, the DRD 100 may perform the role switches described above with reference to FIGS. 1 through 7. The DRD 100 includes a bus 110, a processor 120, a MAC/Physical Layer (PHY) block 130, a data memory 140, and a program memory 150. The DRD 100 may be the host DRD 10 or the device DRD 20. The MAC/PHY block 130 includes an MAC block and a PHY block.

The program memory 150 stores a program for executing the role switching methods described above with reference to FIGS. 1 through 7. The program memory 150 may include a non-volatile memory such as a flash electrically erasable programmable read-only memory (EEPROM), a phase change random access memory (PRAM), or a magnetic random access memory (MRAM). The program memory 150 may be embedded in the DRD 100 or may be independently connected to a predetermined interface (not shown) connected to the bus 110.

As described above with reference to FIGS. 1 and 2, the data packet including the role switching request command DN_RS_INFO output from the device DRD 20 is received by the DRD 100 which corresponds to the host device 10, via the MAC/PHY block 130, in operation S12. The DRD 100 which corresponds to the host device 10 is hereinafter referred to as a host DRD 100. Accordingly, the data packet is transmitted to the MAC block via the PHY block, and the data packet received via the MAC/PHY block 130 is stored in the data memory 140 via the bus 110. For example, a payload may be stored in the data memory 140. For example, the data memory 140 may include a volatile memory such as a dynamic random access memory (DRAM) or a synchronous DRAM (SDRAM), or into a non-volatile memory such as a flash EEPROM, a PRAM, or a MRAM.

The processor 120 performs the program stored in the program memory 150 for executing the role switching methods, for example, as described above. In greater detail, the processor 120 reads out at least a part of the data packet stored in the data memory 140 and performs the role switching methods according to the program. Accordingly, the processor 120 determines whether to accept or refuse a role switch in response to a role switching request command.

If the host DRD 100 accepts the role switch in response to the role switching request command in operation S14, the host DRD 100 transmits M consecutive MMCs (or MMC packets) to the device DRD 20, in operation S16. Here, M is a positive integer, for example, 3. As described above with reference to FIGS. 5 and 6, a data packet including an RSI (for example, the first RSI RSI#1 (for example, ‘11’)) output from the device DRD 20, for example, the WiMedia Superframe, is received by the host DRD 100 via the MAC/PHY block 130, in operation S31. The data packet received via the MAC/PHY block 130 is stored in the data memory 140 via the bus 110.

The processor 120 performs the program stored in the program memory 150 for executing the role switching methods, for example, as described above. In greater detail, the processor 120 reads out at least a part of the data packet stored in the data memory 140 and performs the role switching methods according to the program. Accordingly, the processor 120 determines whether to accept or refuse a role switch in response to a role switching request command. For example, when the processor 120 does not accept a role switch as in case I, the processor 120 transmits the second RSI RSI#2, for example, ‘10’, to the device DRD 20 via the MAC/PHY block 130, in operation S33. On the other hand, when the processor 120 accepts the role switch as in case II, the processor 120 transmits the second RSI RSI#2′, for example, ‘01’, to the device DRD 20 via the MAC/PHY block 130, in operation S41.

As described above with reference to FIG. 8, a host DRD and a device DRD transceives the data packet illustrated in FIG. 2, 3, or 6 via the MAC/PHY block 130. The processor 120 executes the program for performing a role switch operation according to an exemplary embodiment of the present inventive concept, and determines execution or non-execution of a role switch on the basis of the data packet received via the MAC/PHY block 130, for example, the data packet illustrated in FIG. 2 or 6.

The DRD 100 of FIG. 8 may further include an image sensor (not shown) for capturing an image. In this case, an image signal output from the image sensor may be transmitted to at least one of the group consisting of the processor 120 and the data memory 140 via the bus 100. The processor 120 may process the image signal output from the image sensor or an image signal output from the data memory 140 and transmit the processed image signal to another DRD via the MAC/PHY block 130. The processor 120 may store the processed image signal in the data memory 140. The DRD 100 may further include at least one input/output interface for interfacing the DRD 100 with at least one external device.

In a point-to-point DRD according to one or more embodiments of the present invention and a role switching method performed in the point-to-point DRD, both a default link and a reverse link are not needed to be maintained simultaneously in contrast with a conventional point-to-point DRD to thereby reduce overhead and to reduce the amount of power consumed by devices that constitute the point-to-point DRD. Therefore, the point-to-point DRD and the role switching method according to the one or more exemplary embodiments of the present inventive concept may release not-used channel resources, thereby increasing channel usability.

While exemplary embodiments of the present inventive concept have been particularly shown and described with reference to the figures, it will be understood that various changes in form and details may be made therein without departing from the spirit and scope of the inventive concept.

What is claimed is:

1. A method for switching a dual role device (DRD) between the roles of a host and a device, comprising:
receiving, by a first DRD, a command from a second DRD that requests a role switch; and
consecutively transmitting, by the first DRD, M micro-scheduled management commands (MMCs) to the second DRD when the first DRD accepts the role switch request command, wherein M is a positive integer, and wherein the second DRD switches roles to become a first DRD and the first DRD switches roles to become a second DRD upon accepting the role switch request command.

2. The method of claim 1, wherein the first DRD is a host DRD before the role switch and is a device DRD after the role switch and wherein the second DRD is a device DRD before the role switch and is a host DRD after the role switch.

3. The method of claim 1, wherein the first DRD is a device DRD before the role switch and is a host DRD after the role switch and wherein the second DRD is a host DRD before the role switch and is a device DRD after the role switch.

4. The method of claim 2, wherein each of the M MMCs comprises a connection host identifier (CHID) and a role switch acknowledgement information element (IE) that includes information about timing when the second DRD is to transmit the MMCs to the first DRD.

5. The method of claim 2, wherein the second DRD transmits the request command including a connection device ID (CDID) to the first DRD via a device notification time slot (DNTS).

6. The method of claim 1, wherein M is 3.

7. The method of claim 3, further comprising:
determining, by the second DRD, when a role switch is desired; and
consecutively transmitting, by the second DRD, M MMCs to the first DRD, wherein the M is a positive integer,
wherein each of the M MMCs comprises a role switch IE.

8. The method of claim 2, further comprising:
receiving, by the first DRD, a first superframe including a first indicator from the second DRD when it is desired that the second DRD switch to the roll of a host; and
transmitting, by the first DRD, to the second DRD a second superframe comprising a second indicator, the second indicator having values identical to or different from values of an indicator previously transmitted to the current device DRD, in response to the received first indicator.

9. The method of claim 8, wherein each of the first and second indicators is included in a wireless universal serial bus (W-USB) application specific information element (ASIE) of a beacon slot.

10. The method of claim 8, wherein each of the first and second indicators comprises 2 bits.

11. The method of claim 8, wherein:
the second DRD continuously plays a device role in response to the second indicator having the identical values; and
the second DRD plays a host role in response to the second indicator having the different values.

12. A method for switching a dual role device (DRD) between the roles of a host and a device, comprising:
transmitting, by a current host DRD, a first superframe including a first indicator that indicates a role switch to a current device DRD when it is desired that the current host DRD switch to a device role and the current device DRD switch to a host role; and
transmitting, by the current device DRD whose role is switched to the role of a host DRD in response to the first indicator, a second superframe including a second indicator to the current host DRD whose role is switched to the role of a device DRD.

13. The role switching method of claim 12, wherein each of the first and second indicators is included in an ASIE of a WiMedia superframe.

14. A recording medium having recorded thereon a computer program for executing the method of claim 1.

15. A dual role device (DRD) comprising:
a processor; and
a program storage device readable by the DRD, embodying a program of instructions executable by the processor to perform method steps for switching the DRD between the roles of a host and a device, the method comprising:
receiving, by the DRD, a command from a device DRD that requests a role switch;
consecutively transmitting, by the DRD, M micro-scheduled management commands (MMCs) to the device DRD when the DRD accepts the role switch request command, wherein M is a positive integer,
wherein the DRD switches to a role of a device DRD upon accepting the role switch request command, and
wherein the role switch request command includes a superframe comprising a first indicator from an external device DRD via a MAC/PHY block when the external device DRD wants to switch to a host role, and transmits a second superframe comprising a second indicator, the second indicator having values identical to or different from a value of an indicator previously transmitted to the external device DRD, to the external device DRD via the MAC/PHY block in response to the received first indicator.

16. The DRD of claim 15, wherein each of the first and second indicators is included in a W-USB ASIE of a beacon slot.

17. The DRD of claim 15, wherein each of the first and second indicators comprises 2 bits.

18. The DRD of claim 15, wherein:
the second indicator having the identical values is an indictor that allows the external device DRD to play a role of a device DRD; and
the second indicator having the different values is an indictor that allows the external device DRD to play a role of a host DRD.
